(19) United States
(12) Patent Application Publication
(10) Pub. No.: US 2004/0067299 A1
(43) Pub. Date: Apr. 8, 2004

(54) Method for preparing a starch-based grain designed to be included in a food product

(76) Inventors: Andre Granger, Forsthheim (FR); Philippe Zugmeyer, Saverne (FR)

Correspondence Address: FITZPATRICK CELLA HARPER & SCINTO, 30 ROCKEFELLER PLAZA, NEW YORK, NY, 10112, US

(21) Appl. No.: 10/415,939

(22) PCT Filed: Nov. 7, 2001
(86) PCT No.: PCT/FR01/03443

(30) Foreign Application Priority Data
Nov. 7, 2000 (FR) 00/14242

(51) Int. Cl. A23L 1/05

(52) U.S. Cl. 426/661

(57) ABSTRACT

The invention concerns a method for preparing a starch-based grain designed to be included in a food product comprising steps which consist in: cooking the granule by causing it to absorb water, and immersing the granule at least once in a syrup.

The invention relates to food products, in particular frozen products, comprising a starch-based grain such as rice.

No method is presently known which is truly efficient for integrating a starch-based ingredient such as rice into ice cream products. The problem results from the fact that an ice cream is generally frozen at a temperature of between −25° C. and −18° C. Under these conditions, rice which has been cooked and then frozen becomes hard because of the quantity of water which it contains. It does not therefore give in the mouth a pleasant sensation during consumption of the product.

One aim of the invention is to provide a method for preparing a grain comprising starch which confers on the grain a texture making it suitable for incorporation into a food product such as a frozen product.

In order to achieve this aim, there is provided according to the invention a method for preparing a starch-based grain designed to be incorporated into a food product, the method comprising the steps consisting in:

cooking the grain so that it absorbs water; and

immersing the grain at least once in a syrup.

At the end of such a method, the grain has good homogeneity at the freezing temperature (in particular in the range between −25° C. and −18° C.). It also has a stable and soft texture during mastication at this same temperature. This texture therefore has taste benefits during tasting of the food product. Furthermore, the stability of the grain allows it to be incorporated into frozen products with a high water content such as ice creams, while slowing, once incorporated into ice cream, the reabsorption of water by the grain.

There is also provided according to the invention a method for preparing a food product, this method comprising the steps consisting in:

cooking a starch-based grain so that it absorbs water;

immersing the grain at least once in a syrup; and

incorporating the grain into a food composition.

The methods according to the invention may in addition have at least one of the following characteristics:

the product is a frozen product;

after the cooking stage, the grain is rinsed at least once;

during immersion, the syrup is at a temperature of between 90 and 150° C.;

the syrup with the immersed grain is allowed to cool;

the or each immersion stage lasts for at least one hour;

the grain is immersed several times in syrup, the grain being drained between immersions;

after immersion in the first syrup, the grain is drained, a fraction of the first syrup is recovered, and then this fraction is incorporated into the second syrup before immersing the grain in the second syrup;

the syrup or one of the syrups comprises a polysaccharide and/or a polyol;

the syrup or one of the syrups contains a flavoring;

the syrup or one of the syrups contains a coloring; and

the grain is rice.

There is also provided according to the invention a grain prepared by means of the method according to the invention.

There is finally provided according to the invention a food, in particular frozen, product comprising a grain prepared by means of the method according to the invention.

A preferred embodiment of the invention, given by way of a nonlimiting example, will now be described.

In the embodiment which is going to be described, the method of preparation according to the invention is used for preparing a frozen, sweetened food product such as an ice cream comprising a starch-based grain which is in this instance round-grain rice.

The preparation of the rice is carried out in the following manner.

In stage 1, the rice is first of all cooked. In this instance, 0.3 kg of rice is immersed in 2.5 kg of boiling water for 20 min. This cooking is thus carried out in a sufficient time to obtain gelatinization of the starch. The rice has, at the end of this stage, a soft texture. It has absorbed a lot of water.

In stage 2, the still hot, cooked rice is rinsed with 1.5 kg of water. During this stage, the rice is mixed with this water and the mixture is allowed to drain. The entire operation is repeated a second time. This double operation of rinsing after draining is aimed at removing as much starch as possible from the surface of the rice grains.

At stage 3, a syrup formed of 40% water and 40% sorbitol is prepared. The remaining 20% is formed of conventional ingredients for the manufacture of industrial food products. This syrup is heated until boiling is obtained.

At stage 4, this boiling syrup is poured over the rice and the rice thus immersed is left for 24 h in an environment at room temperature. During this period, the syrup and the rice cool to room temperature. When the syrup is poured over the rice, the syrup will be advantageously at a temperature of between 90 and 150° C., preferably between 110 and 130° C. and in this instance at 120° C.

At stage 5, the rice is drained.

During stage 6, the drainings (which correspond here to a quantity of 2.6 kg) are collected and the whole is reconcentrated by adding to the syrup thus collected 200 g of dextrose and 200 g of maltodextrin 19DE. This syrup is brought to the boil.

During stage 7, this boiling syrup is poured over the rice and the rice is again left immersed in this syrup for 24 h at room temperature so that the whole cools gradually to room temperature.

At stage 8, the rice is again drained.

Stage 9 then consists in repeating three times all the abovementioned stages 6, 7 and 8. It can therefore be seen that the method comprises a succession of operations of immersing the rice in a boiling sugar syrup having an increasing sugar concentration. The drainings are every time recovered, reconcentrated with sugar and brought to the boil before being poured over the rice.

Before cooking, the rice contains about 10% water. After cooking in water, the rice contains about 75 to 90% water. The rice candied by means of the method according to the invention finally contains between 36 and 40% water, which gives its texture the desired softness.

The sugars used during this method may be chosen from polysaccharides and polyols.

It can be seen that this method of preparing rice is in fact a rice confectionery process in the true sense, for example for adapting its characteristics to a use in a frozen medium. The method is based on gradual absorption of sugar by the rice as a replacement for a fraction of the water which it initially contains.

It is possible to incorporate, into at least one of the syrups used during the method, one or more coloring and/or flavoring agents added as a mixture to the syrup, which allows the rice, after the preparation, to have a wide variety of colors and tastes.

At the end of this method, the rice has a homogeneous and soft texture allowing it to be used in a wide variety of applications in order to incorporate it into various sweetened food compositions or products, in particular frozen products such as ice creams. It will thus be possible to incorporate the rice into a sorbet, a water ice or into fruits or a frozen dessert or sandwich. However, the product may be intended to be consumed at room temperature, for example, in a cake or a milk dessert. The incorporation of the grain into the product may be carried out in the form of a filling, a coating, a surface decoration of the product, one or more layers inside or outside the product or inclusions in the product.

It will be possible to carry out the method of the invention by means of a starch-based grain other than rice, for example a cereal such as wheat. Of course, it will be possible to carry out the method with other types of rice other than round-grain rice.

1. A method for preparing a starch-based grain designed to be incorporated into a food product, characterized in that it comprises the steps consisting in:
cooking the grain so that it absorbs water; and
immersing the grain at least once in a syrup.

2. A method for preparing a food product, characterized in that it comprises the steps consisting in:
cooking a starch-based grain so that it absorbs water;
immersing the grain at least once in a syrup; and
incorporating the grain into a food composition.

3. The method as claimed in claim 2, characterized in that the product is a frozen product.

4. The method as claimed in any one of claims 1 to 3, characterized in that, after the cooking stage, the grain is rinsed at least once.

5. The method as claimed in any one of claims 1 to 4, characterized in that during immersion, the syrup is at a temperature of between 90 and 150° C.

6. The method as claimed in claim 5, characterized in that the syrup with the immersed grain is allowed to cool.

7. The method as claimed in any one of claims 1 to 6, characterized in that the or each immersion stage lasts for at least one hour.

8. The method as claimed in any one of claims 1 to 7, characterized in that the grain is immersed several times in syrup, the grain being drained between immersions.

9. The method as claimed in any one of claims 1 to 8, characterized in that the grain is immersed in a first syrup, and then the grain is immersed in a second syrup different from the first syrup.

10. The method as claimed in claim 9, characterized in that, after the immersion in the first syrup, the grain is drained, a fraction of the first syrup is recovered, and then this fraction is incorporated into the second syrup before immersing the grain in the second syrup.

11. The method as claimed in any one of claims 1 to 10, characterized in that the syrup or one of the syrups comprises a polysaccharide and/or a polyol.

12. The method as claimed in any one of claims 1 to 11, characterized in that the syrup or one of the syrups contains a flavoring.

13. The method as claimed in any one of claims 1 to 12, characterized in that the syrup or one of the syrups contains a coloring.

14. The method as claimed in any one of claims 1 to 13, characterized in that the grain is rice.

15. A grain, characterized in that it was prepared by means of the method as claimed in claim 1.

16. A food, in particular frozen, product, characterized in that it comprises a grain prepared by means of the method of claim 1.
